(19) United States
(12) Patent Application Publication
(10) Pub. No.: US 2017/0233250 A1
(43) Pub. Date: Aug. 17, 2017

(54) LITHIUM SULFIDE-GRAPHENE OXIDE COMPOSITE MATERIAL FOR LI/S CELLS

(71) Applicant: The Regents of the University of California, Oakland, CA (US)

(72) Inventors: Elton J. Cairns, Walnut Creek, CA (US); Yoon Hwa, Emeryville, CA (US)

(73) Assignee: The Regents of the University of California, Oakland, CA (US)

(21) Appl. No.: 15/502,571

(22) PCT Filed: Aug. 12, 2015
(86) PCT No.: PCT/US2015/044772

§ 371 Date: Feb. 8, 2017

Related U.S. Application Data
(60) Provisional application No. 62/036,390, filed on Aug. 12, 2014.

(51) Int. Cl. H01M 10/052; H01M 4/58; H01M 4/38; H01M 4/36; C01B 17/24; H01M 4/62

(52) U.S. Cl. CPC C01B 17/24; C01B 31/043; H01M 4/5815; H01M 4/625; H01M 10/052; H01M 4/366; H01M 4/38; C01P 2002/82; C01P 2004/62; C01P 2006/40; C01P 2004/04; C01P 2002/72

(57) ABSTRACT

The disclosure provides methods for producing Li₂S-graphene oxide (Li₂S-GO) composite materials. The disclosure further provides for the Li₂S-GO made therefrom, and the use of these materials in lithium-sulfur batteries.

### CROSS REFERENCE TO RELATED APPLICATIONS

This application claims priority under 35 U.S.C. §119 from Provisional Application Ser. No. 62/036,390, filed Aug. 12, 2014, the disclosure of which is incorporated herein by reference.

### TECHNICAL FIELD

The disclosure provides methods for producing lithium sulfide graphene oxide composite materials.

### BACKGROUND

Conventional rechargeable Li-ion cells have not met all of the challenges for satisfying market demands. For example, high specific energy of up to 400 Wh/kg is needed for development of advanced electric vehicles, but current Li-ion cells only can provide ˜200 Wh/kg (theoretically 580 Wh/kg).

### SUMMARY

The disclosure provides a composition comprising nanoparticulate spheres having lithium sulfide with embedded graphene oxide (Li₂S/GO). In one embodiment, the composition further comprises a conformal carbon coating surrounding the Li₂S/GO. Thus, in one embodiment, the disclosure provides a composition comprising lithium sulfide graphene oxide core and a conformal carbon coating. In a further embodiment of any of the foregoing, the lithium sulfide core comprises embedded graphene oxide. In yet a further or alternate embodiment, the graphene oxide and lithium sulfide are heterogeneously dispersed. In still another embodiment, the graphene oxide and lithium sulfide are substantially homogenously dispersed. In another embodiment of any of the foregoing embodiments, the lithium sulfide graphene oxide core has a width or diameter of about 200 nm to 1400 nm. In yet another embodiment of any of the foregoing, the lithium sulfide graphene oxide core has an average width or diameter of about 800 nm. In still another embodiment, the conformal carbon coating comprises a shell around the lithium sulfide graphene oxide core. In a further embodiment, the conformal carbon coating is about 5-45 nm thick. In still a further embodiment, the average thickness of the conformal carbon coating is about 25 nm.

The disclosure also provides a method to synthesize a lithium sulfide-graphene oxide composite material as described herein and above. The method comprises adding a first solution comprising elemental sulfur in a nonpolar organic solvent to a second solution comprising dispersed graphene oxide in a dispersing solvent and adding a strong lithium based reducing agent to make a reaction mixture; and precipitating the Li₂S-GO material from the reaction mixture by heating the reaction mixture at an elevated temperature for 2 to 30 minutes. In a further embodiment, the method further comprises collecting the precipitated Li₂S-GO material from the reaction mixture, washing the Li₂S-GO material and drying the Li₂S-GO material. In still another embodiment, the nonpolar organic solvent is selected from pentane, cyclopentane, hexane, cyclohexane, oxtane, benzene, toluene, chloroform, tetracloroethylene, xylene, 1,2-dichlorobenzene, 1,4-dioxane, carbon disulfide and diethyl ether. In a specific embodiment, the nonpolar organic solvent is toluene. In another embodiment of any of the foregoing embodiments, the strong lithium based reducing agent is selected from the group consisting of lithium triethylborohydride, n-butyl-lithium, and lithium aluminum hydride. In still another embodiment of any of the foregoing the dispersing solvent is selected from the group consisting of acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, dichlorobenzene, dichloromethane, diethyl ether, diethylene glycol, diglyme (diethylene glycol, dimethyl ether), 1,2-dimethoxyethane (DME, glyme), dimethylether, dimethylformamide (DMF), dimethyl sulfoxide (DMSO), dioxane, ethanol, ethyl acetate, ethylene glycol, glycerin, heptane, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, petroleum ether (ligroine), 1-propanol, 2-propanol, pyridine, tetrahydrofuran (THF), toluene, triethyl amine, o-xylene, m-xylene and p-xylene. In another embodiment of any of the foregoing, the method further comprises coating the Li₂S/GO spheres with carbon to form a Li₂S/GO particle coated with a conformal carbon layer (Li₂S/GO@C). In another embodiment, the coating is performed by chemical vapor deposition (CVD). In still another embodiment, the coating is performed by pyrolyzing a carbon-based polymer on the spheres under an inert atmosphere so as to form a pyrolytic carbon based coating. In still a further embodiment, the coating is applied in a rotating furnace. In a further embodiment, the carbon based polymer is selected from polystyrene (PS), polyacrylonitrile (PAN), polymetylmetacrylate (PMMA), or combinations thereof. In still a further embodiment, the polymer coated Li₂S/GO spheres are pyrolyzed by heating the material at a temperature between 400° C. to 700° C. for up to 48 hours.

The disclosure also provides a Li₂S/GO material made by a method as described above. The disclosure also provides a Li₂S/GO@C material made a method described above.

The disclosure also provides an electrode comprising the Li₂S/GO material of the disclosure.

The disclosure provides a lithium/sulfur battery comprising the electrode of the disclosure comprising a Li₂S/GO material.

The disclosure also provides an electrode comprising the Li₂S/GO@C material of the disclosure.

The disclosure also provides a lithium/sulfur battery comprising the electrode comprising Li₂S/GO@C material.

The disclosure provides a method to synthesize a lithium sulfide-graphene oxide composite material comprising: adding a first solution comprising elemental sulfur in a nonpolar organic solvent to a second solution comprising dispersed graphene oxide and adding a strong lithium based reducing agent to make a reaction mixture; precipitating the Li₂S-GO material from the reaction mixture by heating the reaction mixture at an elevated temperature for 2 to 30 minutes. In one embodiment, the method further comprises: collecting the precipitated Li₂S-GO material from the reaction mixture; washing the Li₂S-GO material; and drying the Li₂S-GO material. In yet another embodiment of any of the foregoing, the nonpolar organic solvent is selected from pentane, cyclopentane, hexane, cyclohexane, benzene, toluene, chloroform, 1,4-dioxane, carbon disulfide and diethyl ether. In yet a further embodiment, the nonpolar organic solvent is toluene. In yet another embodiment of any of the foregoing, the strong lithium based reducing agent is selected from lithium triethylborohydride, n-butyl-lithium, and lithium aluminum hydride. In yet another embodiment of any of the foregoing, the first solution comprises 64 mg of sulfur dissolved in 3.5 mL of the nonpolar organic solvent. In yet a further embodiment, 3.5 mL of the first solution is added to a second solution which comprises graphene oxide dispersed in THF. In yet another embodiment of any of the foregoing, the strong lithium based reducing agent comprises 1.0 M lithium triethylborohydride in 4.2 mL of tetrahydrofuran. In yet another embodiment of any of the foregoing, the reaction mixture is heated at about 90° C. In a further embodiment, the reaction mixture is heated for about 7 minutes to about 10 minutes. In another embodiment, the Li₂S material in the graphene oxide composite is about 1 μm in diameter.

The disclosure also provides a composite Li₂S-GO material made by the method described by any of the foregoing embodiments.

In another embodiment, the disclosure provides an electrode comprising the Li₂S-GO material of the disclosure.

The disclosure also provides a lithium/sulfur battery comprising the electrode of the disclosure.

### DESCRIPTION OF DRAWINGS

FIG. 1A-E shows a synthesis scheme and characterization of Li₂S/GO@C nanospheres. (A) Schematic illustration of a synthesis method of the disclosure; (B) XRD patterns and (C) Raman spectra at each step. (D) Schematically depicts a Li₂S/GO@C nanosphere of the disclosure. (E) Depicts a Li₂S/GO core material.

FIG. 2A-E SEM images of (A) as-synthesized Li₂S/GO, (B) heat-treated Li₂S/GO, and (C) Li₂S/GO@C nanospheres. (D) Elemental mapping of Li₂S/GO@C nanosphere by energy filtered transmission electron microscope (EFTEM, inset: zero loss image of Li₂S/GO@C nanosphere). (E) TEM image of hollow carbon nanosphere including GO in its structure obtained by removal of Li₂S from the Li₂S/GO@C nanosphere.

FIG. 3A-C shows Electrochemical test results of synthesized Li₂S, Li₂S/GO, Li₂S/GO@C-NR, and Li₂S/GO@C electrode. (A) Voltage profiles of the electrodes at the 0.2 C rate. (B) Comparisons of cycling performances of the electrodes at 0.2 C. (C) Test time vs discharge capacity plots of the electrodes for 50 cycles at 0.2 C.

FIG. 4 shows a schematic illustration of carbon deposition process using the conventional CVD method and CVD using the rotating furnace.

FIG. 5A-E shows electrochemical performance of the Li₂S/GO@C electrode. (A) Voltage profiles and (B) cycling performance of the electrodes cycled at various rates. (C) Voltage profiles of the electrode discharged at 2.0 C and charged at 1.0 C. (D) Voltage profiles of the electrode at 0.05 C after hundreds of cycles. (E) Long-term cycling performance of the electrode for 1500 cycles.

FIG. 6 shows coulombic efficiency of a Li₂S/GO@C electrode cycled at various C-rates.

FIG. 7 shows differential capacity plot (DCP) of Li₂S/GO@C electrode corresponding to the voltage profiles shown in FIG. 5c.

### DETAILED DESCRIPTION

As used herein and in the appended claims, the singular forms “a,” “and,” and “the” include plural referents unless the context clearly dictates otherwise. Thus, for example, reference to “a Li₂S material” includes a plurality of such materials and reference to “the graphene oxide” includes reference to one or more graphene oxide materials and equivalents thereof known to those skilled in the art, and so forth.

Also, the use of “and” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

All publications, patents, and patent applications mentioned in this specification are herein incorporated by reference to the same extent as if each individual publication, patent, or patent application was specifically and individually indicated to be incorporated by reference. All publications, patents, and patent applications mentioned in this specification are herein incorporated by reference in its entirety as well as any references cited therein.

Unless defined otherwise, all technical and scientific terms used herein have the same meaning as commonly understood to one of ordinary skill in the art. Although many methods and reagents similar or equivalent to those described herein, the exemplary methods and materials are presented herein.

Because of the limitations of current Li-ion cells, research continues to try and increase their performance. Many researchers have been trying to develop advanced battery systems such as Li/S cells and redox flow batteries. Among them, the Li/S cell is one of the strong candidates to replace current lithium ion cells due to its high theoretical specific energy of 2680 Wh/kg. This high theoretical specific energy is because of the high theoretical specific capacity of sulfur cathode (1675 mAh/g), which is almost 10 times larger than that of conventional cathode materials for Li-ion cells. The reaction of the sulfur cathode with Li ions is as follows:

S+2Li⁺+2e⁻ [symbol] Li₂S (eq. 1)

Considering the challenges for the sulfur cathode, fully lithiated sulfur, lithium sulfide (Li₂S), is an attractive cathode material for lithium/sulfur (Li/S) cells, with a theoretical specific capacity of 1166 mAh g⁻¹. It can be paired with different kinds of lithium metal free materials, such as the high capacity silicon anode. Moreover, compared with sulfur, Li₂S has a higher melting point and is in the maximum volume state, so modifications on Li₂S materials can be performed at a higher temperature and the surface coating can be more stable. Nevertheless, the problems of low electronic conductivity, and the solubility of polysulfides in many electrolytes still exist for Li₂S cathodes. Thus, the use carbon-containing composites including graphene oxide, controlling particle size and providing protection for the Li₂S active materials are important considerations to be taken into account.

Despite the high theoretical specific capacity, several issues have to be overcome such as a large volume change during cycling, polysulfide dissolution into organic electrolytes and low electrical conductivity of sulfur. During the reaction of sulfur with Li (eq. 1), a volume change of active material of up to 80% takes place and this large volume change can cause pulverization of the electrode. Besides, intermediate species such as Li₂S₈, Li₂S₆ and Li₂S₄ are soluble in most organic electrolytes, which is one of main reasons for capacity degradation during cycling. Furthermore, lithium metal used as the anode material for Li/S cells typically forms dendrites during recharge in conventional organic liquid electrolytes, causing shorting of the cell.

A liquid electrolyte is conventionally employed, which has a high solubility of lithium polysulfides and sulfide. The utilization of sulfur in batteries containing liquid electrolyte depends on the solubility of these sulfur species in the liquid electrolyte. Further, the sulfur in the positive electrode, e.g., cathode, except at the fully charged state, can dissolve to form a solution of polysulfides in the electrolyte. During discharge, the concentration of polysulfide species Sₙ²⁻ with n greater than 4 at the positive electrode is generally higher than that at the negative electrode, e.g., anode, and the concentration of Sₙ²⁻ with n smaller than 4 is generally higher at the negative electrode than the positive electrode. The concentration gradients of the polysulfide species drive the intrinsic polysulfide shuttle between the electrodes. The polysulfide shuttle (diffusion) transports sulfur species back and forth between the two electrodes, in which the sulfur species may be migrating within the battery all the time. The polysulfide shuttle leads to poor cyclability, high self-discharge, and low charge-discharge efficiency. Further, a portion of the polysulfide is transformed into lithium sulfide (Li₂S), which can be deposited on the negative electrode. The “chemical short” leads to the loss of loss of active material from the sulfur electrode, corrosion of the lithium containing negative electrode, i.e., anode, and a low columbic efficiency. Further, the mobile sulfur species causes the redistribution of sulfur in the battery and imposes a poor cycle-life for the battery, in which the poor cycle life directly relates to micro-structural changes of the electrodes. This deposition process occurs in each charge/discharge cycle, and eventually leads to the complete loss of capacity of the sulfur positive electrode. The deposition of lithium sulfide also leads to an increase of internal resistance within the battery due to the insulating nature of lithium sulfide. Progressive increases in charging voltage and decreases in discharge voltage are common phenomena in lithium/sulfide (Li/S) batteries, because of the increase of cell resistance in consecutive cycles. Hence, the energy efficiency decreases with the increase of cycle number.

The Li₂S cathode suffers from very poor electronic conductivity, polysulfide dissolution and the shuttle effect, which cause low S utilization, low Coulombic efficiency, and rapid degradation during cycling. Therefore, it is also crucial to prevent polysulfide dissolution into the liquid electrolyte and provide good electrical pathways for the Li₂S cathode material, in order to achieve high-rate and long-cycle performance of Li/S cells. Some recent research has been conducted to solve these problems; for example, Li₂S cathodes coated with various materials such as carbon (see, e.g., WO2015103305, which is incorporated herein by reference), two-dimensional layered transition metal disulfides, and conductive polymers. For example, various methods and compositions provide Li₂S encapsulated in a polymeric material or graphene.

Graphene is a carbonaceous material composed of carbon atoms densely packed in a two dimensional honeycomb crystal lattice. The graphene used in the methods and compositions of the disclosure can be pure graphene or functionalized graphene. Pure graphene refers to graphene that includes carbon atoms without other functional groups. The functionalized graphene can include one or more functional groups joined to carbon atoms of graphene. The functionalized graphene (sometimes referred to as graphene derivatives) can be covalently or non-covalently functionalized (such as due to electrovalent bonds, hydrogen bonds, and/or π-π bonds). The one or more functional groups can include, e.g., oxygen containing functional groups, nitrogen containing functional groups, phosphorus containing functional groups, sulfur containing functional groups, hydrocarbon containing functional groups, and halogen containing functional groups. One example of functionalized graphene is graphene oxide. Graphene oxide comprises oxygen containing functional groups. The oxygen containing functional groups can include, e.g., carboxyl groups, carbonyl groups, hydroxyl groups, ester groups, aldehyde groups, and epoxy groups. A single layer of graphene can be used or multi-layer graphene can be laminated together and used. A graphene sheet of the disclosure can comprise from 1-10 layers of graphene laminated together.

In contrast to other compositions comprising Li₂S encapsulated in a second material, this disclosure provides a core material comprising a Li₂S/GO, wherein the graphene oxide or graphene derivative is embedded in the Li₂S particles (e.g., not surrounding, but rather in the Li₂S material). For example, “embedded” refers to the element being present in the surrounding mass vs. “on” the surrounding mass. It should be recognized that “embedded” can refer to a portion being embedded and then separated by surrounding mass from a similar material embedded in the surrounding mass (e.g., a patch in the surrounding mass). Embedded also refers to the material (e.g., graphene oxide) being internal to a surrounding mass.

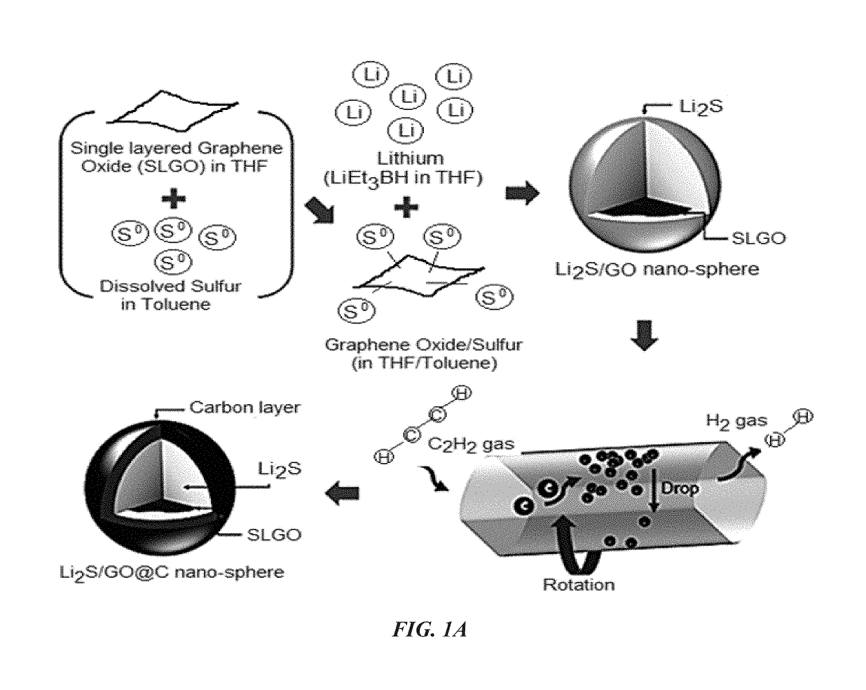

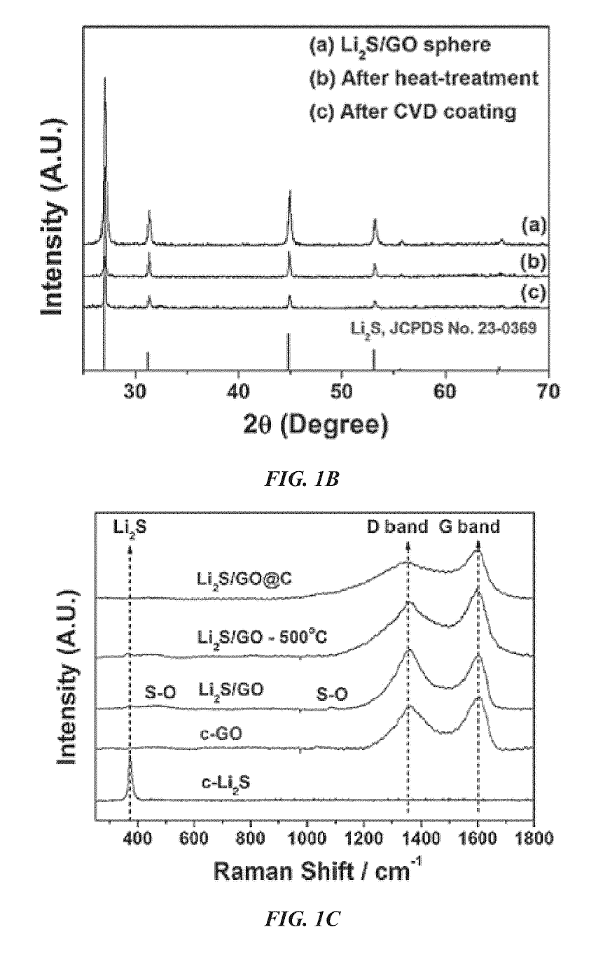

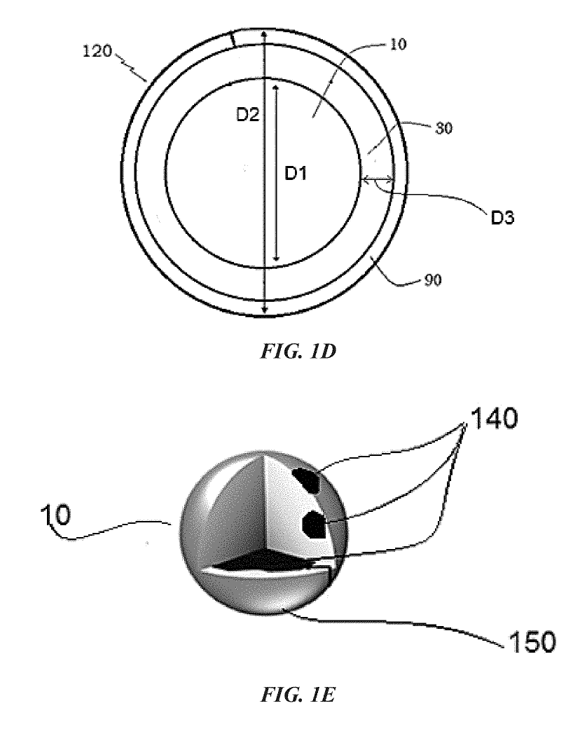

The disclosure provides compositions, uses and methods of making Li₂S/GO nanoparticles, wherein the graphene oxide or derivative is embedded in the Li₂S material. For example, FIG. 1E shows a Li₂S/GO core 10 comprising a Li₂S 150 with embedded graphene oxide or derivative 140. The graphene oxide or derivative 140 can be dispersed within or embedded within the Li₂S material. This is in contrast to the Li₂S being encapsulated by graphene.

The Li₂S/GO particles can be obtained by mixing sulfur (e.g., elemental sulfur or other sulfur source) in a solvent with dispersed graphene oxide, followed by the addition of a lithium-based reducing agent (e.g., lithium triethylborohydride, n-butyl-lithium, and lithium aluminum hydride). In one embodiment, the sulfur is added to a nonpolar organic solvent (e.g., pentane, cyclopentane, hexane, cyclohexane, benzene, toluene, chloroform, 1,4-dioxane, carbon disulfide and diethyl ether). Graphene (e.g., single layer graphene oxide) is prepared by dispersion in a suitable dispersion solvent (e.g., acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, dichlorobenzene, dichloromethane, diethyl ether, diethylene glycol, diglyme (diethylene glycol, dimethyl ether), 1,2-dimethoxyethane (DME, glyme), dimethylether, dimethylformamide (DMF), dimethyl sulfoxide (DMSO), dioxane, ethanol, ethyl acetate, ethylene glycol, glycerin, heptane, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, petroleum ether (ligroine), 1-propanol, 2-propanol, pyridine, tetrahydrofuran (THF), toluene, triethyl amine, o-xylene, m-xylene and p-xylene). In another embodiment, sulfur is dissolved in a non-polar organic solvent, followed by the addition of commercial single-layered graphene oxide (SLGO) dispersed in a suitable dispersion solvent to prepare a uniform S/SLGO composite solution. This S/SLGO composite solution is added to a solution comprising a lithium-based reducing agent and heated with stirring to remove the solvents until stable Li₂S/GO spheres formed. In one embodiment, the solvent has a relatively high vapor pressure and a good solubility for the Li₂S. As the solvent evaporates, the Li₂S is left behind as nano- and/or micro-spheres.

Any number of methods known in the art may be used to produce the Li₂S material disclosure herein. In a particular embodiment, a Li₂S core material of the disclosure can be prepared by a solution-based reaction of elemental sulfur with a strong lithium based reducing agent such as, superhydride (i.e., Li(CH₂CH₃)₃BH), n-butyl-lithium, or lithium aluminum hydride, in any number of non-aqueous solvents (e.g., toluene and THF) and collecting the precipitate. In a one embodiment, the strong lithium based reducing agent is Li(CH₂CH₃)₃)BH. In a certain embodiment, a method of synthesizing a Li₂S material comprises: dissolving elemental sulfur in a nonpolar organic solvent (e.g., toluene) to form a sulfur containing solution; adding the sulfur containing solution to dispersed graphene oxide suspension; adding a strong lithium based reducing agent so as to form a reaction mixture; and precipitating the Li₂S-GO materials from the reaction mixture by heating the mixture at an elevated temperature (e.g., 90° C.) for 2-30 minutes to evaporate the solvent with good solubility for Li₂S (e.g. THF). In a particular embodiment, the reaction is heated at 90° C. for up to 2 minutes, for up to 3 minutes, for up to 4 minutes, for up to 5 minutes, for up to 6 minutes, for up to 7 minutes, for up to 8 minutes, for up to 9 minutes, for up to 10 minutes, for up to 11 minutes, for up to 12 minutes, for up to 13 minutes, for up to 14 minutes or for up to 15 minutes. In another embodiment, the nonpolar organic solvent is selected from pentane, cyclopentane, hexane, cyclohexane, benzene, toluene, chloroform, 1,4-dioxane and diethyl ether. In one embodiment, the nonpolar organic solvent is toluene. In a further embodiment, the method further comprises collecting the precipitated Li₂S-GO powder material and washing the precipitated material, followed by heating under a noble gas to remove organic residue.

In another specific embodiment, sulfur powder is dissolved in toluene, followed by the addition of commercial single-layered graphene oxide (SLGO) dispersed in tetrahydrofuran (THF) to prepare a uniform S/SLGO composite solution. This S/SLGO composite solution is then added to a solution of lithium triethylborohydride (LiEt₃BH) in THF and heated with stirring to remove the THF until stable Li₂S/GO spheres formed.

A graphene sheet or derivative (e.g., a graphene oxide (GO)) can be dispersed in a solvent by mechanically stirring or ultrasonically agitating, to form a dispersed suspension. The solvent should be able to allow dispersion of the graphene. In one embodiment, the solvent is able to completely evaporate during the heating step. In a specific embodiment, the solvent is THF.

A sulfur-source can be dissolved in an appropriate solvent that is the same or different than the solvent used to disperse the graphene or graphene oxide. A sulfur-source for use in the methods and compositions of the disclosure can be, e.g., a salt, an acid, or an oxide of sulfur. For example, the sulfur-source can be thiosulfates, thiocarbonates, sulfites, metal sulfides (MₓS_{y}), sulfur dioxide, sulfur trioxide, hydrogen sulfide, thiosulphuric acid, thiocarbonic acid, sulfurous acid, or combinations thereof. The thiosulfate can be at least one of sodium thiosulfate, potassium thiosulfate, lithium thiosulfate and ammonium thiosulfate. The metal sulfide can be at least one of sodium sulfide, potassium sulfide, and lithium sulfide.

The formed Li₂S/GO particles can then be further modified (e.g., encapsulated in a polymer, carbon or other material) and used. For example, disclosure provides a composite active material comprised of Li₂S with embedded graphene oxide (GO) for use in a sulfur cathode that overcomes the current issues for application of Li/S cells. In this embodiment, the GO not only acts as an immobilizer to hold the S, but can also provide a stable electrical pathway during cycling, leading to enhanced cycle performance and rate capability of the electrode. As mentioned, a Li₂S cathode has a high theoretical specific capacity and it can be paired with lithium metal free anodes, such as carbon, silicon and tin based anodes. Moreover, Li₂S (M.P.: 1372° C.) has a much higher melting point than S (M.P.: 115 C) and is in the maximum volume state, so modifications on the surface of Li₂S particles can be easily performed at a higher temperature and the surface coating can be relatively more stable.

The disclosure also provides compositions, uses and methods of making Li₂S/GO nanospheres with a conformal carbon coating on the surface (Li₂S/GO@C). The strategies of using Li₂S/GO@C to improve the cell performance are as follows: (i) the conformal carbon coating not only prohibits polysulfide dissolution into the electrolyte by preventing direct contact between Li₂S and the liquid electrolyte, but also acts as an electrical pathway resulting in the reduction of the electrode resistance; (ii) the spherical shape of the submicron size particles can provide a short solid-state Li diffusion pathway and better structural stability of the carbon shell during cycling; (iii) void space will be created within the carbon shell during charge, which provide enough space to accommodate the volume expansion of up to 80% during discharge. As a result, better structural stability of the carbon shell can be secured because the carbon shell will not need to expand during cycling; and (iv) even if some percentage of the carbon shells is broken due to physical imperfections, the GO in the particles can act as a second inhibitor for polysulfide dissolution due to its S immobilizing nature.

FIG. 1D depicts a particular embodiment of a Li₂S/GO@C composite 120 which comprises a Li₂S/GO core material 10. A “core material” is a Li₂S/GO based material (see also, FIG. 1E at 10). The term “composite” as used herein denotes that the core material further comprises one or more coating materials. In some embodiments, the composite 120 comprises a Li₂S/GO core material 10, a first coating 30 that is in direct contact and encapsulates the core material 10, and an optional second coating 90 that is in direct contact with and encapsulates the first coating 30. In a further embodiment, the Li₂S/GO core material 10 has a diameter of D1, wherein D1 is between 100 nm to 1500 nm, 200 nm to 1400 nm, 300 nm to 1300 nm, 400 nm to 1200 nm, 500 nm to 1100 nm, or about 600 nm to 1 μm, (it should be apparent that the disclosure contemplates any value between 100 nm and 1500 nm); on average the Li₂S/GO core material has an average width or diameter of about 800 nm. In another embodiment, a Li₂S/GO@C composite material disclosed herein that comprises a Li₂S/GO core material 10 and a first layer 30 has a diameter of D1+D3, wherein D3 is between 1 nm to 50 nm, 5 nm to 45 nm, 10 nm to 40 nm, 15 nm to 35 nm, or 20 nm to 30 nm in diameter. In one embodiment, the first layer 30 has an average thickness (D3) of about 25 nm. In yet another embodiment, a Li₂S/GO@C composite material disclosed herein that comprises a Li₂S/GO core material 10 a first layer 30 and a second layer 90 has a diameter of D2. D2 can be from 102 nm to 1700 nm and any number there between.

In some embodiments, a cathode comprises a Li₂S/GO@C composite 120. Cathodes comprising Li₂S/GO@C composite 120 are suitably employed in a battery, such as a lithium/sulfur (Li/S) battery. In another embodiment, the cathode comprises a Li₂S/GO@C, wherein the Li₂S/GO@C has a core Li₂S/GO 10, a conformal carbon layer 30 and optionally one or more additional layers of a conductive polymer.

In a certain embodiment, a Li₂S/GO core material 10 is prepared by using standard techniques known in the art. For example, the Li₂S/GO core material 10 can be prepared by a solution-based reaction of elemental sulfur and GO with a strong lithium based reducing agent such as, lithium superhydride (e.g., Li(CH₂CH₃)₃)BH), n-butyl-lithium, or lithium aluminum hydride and collecting the precipitate.

In a certain embodiments, Li₂S/GO@C composite 120 comprises a first coating 30 of a conformal carbon material. The first coating 30 can be applied so that the coating uniformly coats the Li₂S/GO core material 10 or alternatively the coating is applied so that the coating does not uniformly coat the Li₂S/GO materials 10 (i.e., portions in which the coating is thicker and portions in which the coating is thinner including porous coatings). Alternatively, a first coating can be patterned on the Li₂S/GO materials 10, such as by using lithography based methods. For example, a first coating can be patterned on the Li₂S/GO materials 10 using digital lithography (e.g., see Wang et al., Nat. Matter 3:171-176 (2004), which methods are incorporated herein) or soft lithography (e.g., see Granlund et al., Adv. Mater 12:269-272 (2000), which methods are incorporated herein). In another embodiment, a second coating 90 can be applied. In one embodiment, the second coating 90 is a porous electronically conductive coating.

In a particular embodiment the first coating 30 comprises carbon. A first coating 30 comprising carbon can be applied to the Li₂S/GO core material 10 by using various techniques. For example, in one embodiment, a carbon-based coating can be applied to the Li₂S/GO materials 10 by using a chemical vapor deposition (CVD) process. In an alternate embodiment, a carbon-based coating can be applied to the Li₂S/GO material 10 by using a carbonization process. For example, Li₂S/GO material 10 can be carbon coated by preparing a mixture comprising a conductive carbon-based polymer, applying the mixture to the Li₂S/GO material 10, and then carbonizing the carbon-based polymer by pyrolysis. The pyrolysis of the carbon based precursor compound is typically carried out in a non-oxygen environment and typically under a stream of inert gas such as, for example, Argon.

In a certain embodiment, a carbonization process is used to coat carbon on the Li₂S/GO materials 10 by pyrolyzing a carbon based precursor compound. During the pyrolysis step, chemical and physical rearrangements occur, often with the emission of residual solvent and byproduct species, which can then be removed. As used in the disclosure, the term “carbon coating by carbonization” means that the carbon coating is generated from pyrolysis of a suitable carbon based precursor compound to amorphous pyrolytic carbon. A suitable precursor carbon compound (e.g., carbon based polymer) can be applied to the Li₂S/GO material by any number of methods known in the art. For example, the Li₂S/GO material can be immersed or soaked in a mixture, solution, or suspension comprising the carbon based precursor compound. Alternatively, a mixture, solution, or suspension comprising the carbon based precursor compound can be applied to the Li₂S/GO material by spraying, dispensing, spin coating, depositing, printing, etc. The carbon based precursor compound can then be carbonized by heating the precursor compound at a suitable temperature, in an appropriate atmosphere, and for a suitable time period so that the carbon based precursor compound undergoes thermal decomposition to carbon.

A carbon based first coating produced by carbonization can result from pyrolyzing a carbon based precursor compound at temperatures of about 300 to 800° C. in a reaction vessel, for example a crucible. Typically, pyrolyzation of the carbon based precursor compound is conducted at a temperature of at least 200° C. and up to 700° C. for a time period of up to 48 hours, wherein, generally, higher temperatures require shorter processing times to achieve the same effect. In a certain embodiment, carbonization of the carbon based precursor compound is conducted by pyrolyzing the carbon precursor at a temperature of at least 425° C. and up to 600° C. for a time period of up to 48 hours. In different embodiments, the temperature employed in the pyrolysis step is 200° C., 250° C., 300° C., 350° C., 400° C., 450° C., 500° C., 550° C., 600° C., 650° C., or 700° C., or within a temperature range bounded by any two of the foregoing exemplary values. For any of these temperatures, or a range therein, the processing time (i.e., time the carbon based precursor compound is processed at a temperature or within a temperature range) can be, for example, precisely, at least, or no more than 15 minutes, 30 minutes, 1 hour, 2 hours, 3 hours, 4 hours, 5 hours, 6 hours, 12 hours, 18 hours, 24 hours, 30 hours, 36 hours, 42 hours, 48 hours, or within a time range bounded by any two of the foregoing exemplary values. Carbonization to produce first coating 30 may include multiple, repeated steps of pyrolysis with the carbon based precursor compound. Between each step, aggregates can be milled to substantial homogeneity, followed by further pyrolysis with additional carbon based precursor compound. The thickness of the carbon-based coating 30 can be modulated by any number of means, including (i) using repeated pyrolysis steps with carbon based precursor compound, (ii) increasing the amount of carbon based precursor applied to the Li₂S/GO materials, and (iii) the type of carbon based precursor compound. The amount of carbon deposited as a coating 30 may be determined by measuring a change in weight before and after applying the coating to the Li₂S/GO material.

Typical carbon based precursor compounds that can be used in the carbonization methods disclosed herein, includes carbon based polymers. For example, inexpensive carbon based polymers such as polystyrene (PS), polyacrylonitrile (PAN), and polymetylmetacrylate (PMMA) can be used. Carbon based polymers, unlike explosive gaseous raw carbon sources, are safe to handle and relatively inexpensive.

In alternate embodiment, a coating 30 is a carbon based coating produced by using a chemical vapor deposition (CVD) process. CVD is a chemical process used to produce high-purity, high-performance solid materials. For the Li₂S/GO@C composites 120 disclosed herein, a carbon-based coating 30 can be deposited onto a Li₂S/GO core material 10 by placing Li₂S/GO core material 10 under an atmosphere comprising a carbon based precursor compound, such as acetylene, and heating at a temperature so as to pyrolyze the precursor compound. In a particular embodiment, a carbon based coating 30 can be deposited onto a Li₂S/GO core material 10 by transferring the Li₂S/GO material to a closed furnace tube in a glove box and introducing an inert gas and carbon based precursor compound (e.g., a hydrocarbon) at a defined Standard Cubic Centimeters per Minute (SCCM) flow rate. In a further embodiment, the SCCM flow rate of the inert gas to carbon based precursor compound is introduced at a defined ratio. In a particular embodiment, the inert gas to the carbon based precursor compound is introduced at a SCCM flow rate ratio of 1:10 to 10:1, 1:9 to 9:1, 1:8 to 8:1, 1:7 to 7:1, 1:6 to 6:1, 1:5 to 5:1, 1:4 to 4:1, 1:3 to 3:1, or 1:2 to 2:1. For example, in a particular embodiment, Argon is introduced at 70 SCCM while acetylene is introduced at 10 SCCM resulting in a SCCM flow rate ratio of 7:1. In another embodiment, the CVD process utilizes a carbon based precursor compound selected from methane, ethylene, acetylene, benzene, xylene, carbon monoxide, or combinations thereof. Depending on the particular carbon based precursor compound, the flow rates can be adjusted to desired values using a mass flow controller. The thickness of the carbon coating can be modulated by adjusting the length of time the Li₂S/GO materials are exposed to the carbon based precursor compound, changing the flow rate of the carbon based precursor compound, and/or changing the deposition temperature. In order to achieve a more even carbon coating, the Li₂S/GO materials can be periodically removed from heat and milled to break up any agglomerations. The Li₂S/GO materials are then reheated with the carbon based precursor compound. The amount of carbon deposited can be determined by the change in weight of the Li₂S/GO materials.

In a specific embodiment, the carbon coating is applied by a chemical vapor deposition process (CVD). In this embodiment, a carbon precursor (e.g., acetylene) in argon is flowed into a rotating furnace and heated to about 700° C. The process is performed, in one embodiment, in a low or oxygen-free, moisture-free environment as Li₂S is sensitive to moisture. In one embodiment, the moisture and oxygen are below 0.1 ppm.

The Li₂S/GO@C composite 120 can optionally comprise a further coating 90, which can assist in the prevention of migration of polysulfide species. The second coating 90 may be applied so that the coating uniformly encapsulates first coating 30 or is applied so that the coating does not uniformly coat first coating 30 (i.e., portions in which the coating is thicker and portions in which the coating is thinner). Alternatively, second coating 90 can be patterned on first coating 30, such as by using lithography based methods.

In one embodiment, a second coating 90 is a conductive polymer selected from polypyrrole (PPy), poly(3,4-ethylenedioxythiophene)-poly(styrene sulfonate) (PEDOT:PSS), polyaniline (PANI), polypyrrole (PPy), polythiophene (PTh), polyethylene glycol, polyaniline polysulfide (SPAn), amylopectin, or combinations thereof.

In an alternate embodiment second coating 90 is a conductive polymer, such as poly(3,4-ethylenedioxythiophene)-poly(styrene sulfonate) (PEDOT:PSS). A conductive polymer second coating 90 can be applied to a composite comprising Li₂S/GO core material 10 and a first coating 30 (e.g., a Li₂S/GO@C composition) by applying the polymer to the composite and drying the polymer to remove water. For example, the polymer can be applied to the composite as either a dispersion of gelled particles in water, dispersion of gelled particles in propanediol, or by spin coating the polymer onto the composite. The conductivity of the composite which comprises a second coating 90 of a conductive polymer may be further improved by treating the composite with various compounds, such as ethylene glycol, dimethyl sulfoxide (DMSO), salts, zwitterions, cosolvents, acids (e.g., sulfuric acid), geminal diols, amphiphilic fluoro-compounds, or combinations thereof.

It is worthwhile to point out that the conformal carbon protection layer can be easily formed using a CVD coating process with a lab-designed rotating tube furnace. The Li₂S/GO@C cathode provided herein has electrochemical performance including, for example, a prolonged cycle life (1500 cycles) at the 2.0 C discharge rate (1.0 C=1.163 A g⁻¹ of Li₂S) with a high initial capacity of 650 mA·h⁻¹ of Li₂S (corresponding to 942 mA·h⁻¹ g⁻¹ of S) and 699 mA·h g⁻¹ of Li₂S (1012 mA·h g⁻¹ of S) at 0.05 C after 400 cycles at 2.0 C discharge; excellent capacity retention of more than 84% with a high Coulombic efficiency of up to 99.7% after 150 cycles at various discharge C-rates (2.0, 3.0, 4.0, and 6.0 C discharge rates).

The syntheses methods disclosed herein may be modified to produce particles having different sizes by adjusting the reaction times and/or increasing or decreasing the amount of sulfur solvent added to the reaction mixture. For example, small size particles can be generated by using shorter reaction times and decreasing the amount of sulfur solvent added to the reaction mixture; and vice versa, larger particles can be generated by using longer reaction times, and increasing the amount of sulfur solvent added to the reaction mixture.

The Li₂S/GO@C nanospheres of the disclosure can be synthesized as shown in FIG. 1A. Briefly, S powder was dissolved in toluene, followed by the addition of commercial single-layered graphene oxide (SLGO) dispersed in tetrahydrofuran (THF) to prepare a uniform S/SLGO composite solution. This S/SLGO composite solution was added to a solution of lithium triethylborohydride (LiEt₃BH) in THF and heated with stirring to remove the THF until stable Li₂S/GO spheres formed. The reaction chemistry of Li2S formation is as follows:

S+2LiEt₃BH→Li₂S+2Et₃B+H₂ (Eq. 2)

The Li₂S formed in chemical reaction above is heterogeneously deposited on the surface of GO followed by obtaining Li₂S/GO nanospheres. A conformal carbon coat is then applied by, for example, a CVD coating process using a lab-designed rotating tube furnace to simply form a conformal carbon protection layer on the surface of the Li₂S/GO nanospheres. During the CVD process, the horizontal furnace tube was rotated to continuously mix the Li₂S/GO powder, and the fresh surface of the Li₂S/GO powder can be covered by carbon resulting in the formation of a conformal carbon coating on the surface of Li₂S/GO nanospheres. The weight ratio of Li₂S:GO:C was approximately 85:2:13. However, the ratios can be easily adjusted such that the Li₂S is 70-90%, the GO is 1-10% and the carbon is 5-20%. A detailed synthesis and characterization procedure is exemplified in the Examples below. As shown in FIG. 1B, all XRD peaks of each sample correspond to Li₂S (Cubic, JCPDS No. 23-0369), which indicates that the Li₂S was successfully formed after the chemical reaction above and no side reaction occurred during the following heat-treatment and CVD carbon coating step. XRD peaks related to GO were not observed due to the poor ordering of the sheets along the stacking direction. However, the existence of GO is clearly demonstrated by Raman spectra of as-synthesized Li₂S/GO spheres (FIG. 1C), which shows two Raman shifts near 1377 and 1588 cm⁻¹ corresponding to the D band and G bands of carbon, respectively, with some organic residue (S—O bonds). Raman peaks corresponding to the organic residues were successfully removed by the heat treatment process at 500° C. under argon (Ar) atmosphere (labeled as Li₂S/GO-500° C.). Based on the changes of the Raman spectra and the color change of the powder (light gray, dark gray), the organic residues are completely carbonized during the heat-treatment process. After carbon coating, the Raman peak of Li₂S at ˜370 cm⁻¹ almost disappeared and the color of the powder became nearly black, which indicates that the carbon deposited by the CVD process successfully covered the surface of Li₂S and blocked the Raman signal of Li₂S.

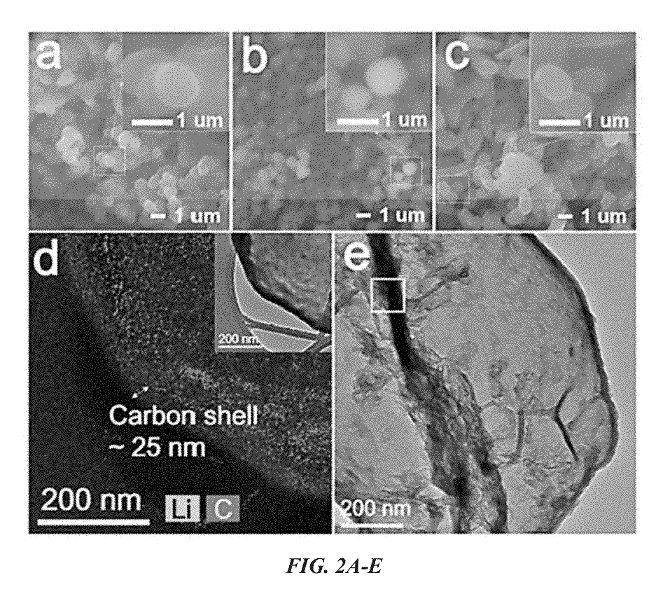

When synthesizing the Li₂S/GO nanospheres, the flake size of GO embedded in the Li₂S spheres, the amount of toluene and the weight ratio between GO and S can influence the size and shape of the product. Therefore, a relatively small amount of SLGO (2 mg) with a flake size of 500-800 nm can be used to obtain the spherical Li₂S/GO nanoparticles. Li₂S/GO of spherical shape with particle size of approximately 800 nm was successfully obtained as confirmed by the scanning electron microscopy (SEM) images shown in FIG. 2A. The particles remained spherical after the heat treatment and the CVD coating processes conducted at 500 and 700° C., respectively, because of the high melting point (1372° C.) of Li₂S, but were interconnected after the CVD coating process, indicating the formation of a continuous carbon shell. Energy dispersive X-ray spectroscopy (EDS) results for the heat-treated Li₂S/GO nanospheres demonstrated the existence of S (corresponding to Li₂S based on the XRD pattern of Li₂S/GO) and C (GO or carbon obtained by carbonization of organic residues) on the particles. Oxygen spectra were also detected but this was mainly due to the high sensitivity of Li₂S to moisture and the formation of small amounts of LiOH during transfer of the Li₂S/GO nanospheres into the SEM chamber. XRD patterns of Li₂S/GO nanospheres exposed to air confirmed the formation of LiOH.

The disclosure further provides that the Li₂S/GO@C materials disclosed herein or the composites made thereof can be used in a variety of applications, including for use in Li/S batteries. In comparison to conventional Li/S cells the Li/S cells comprising the Li₂S/GO@C materials have higher energy densities, lower material costs, and better cycling performance. Accordingly, Li/S cells comprising the Li₂S/GO@C materials could be used in high performance batteries in vehicles, electronic devices, electronic grids and the like. In a particular embodiment, a battery comprises the Li₂S/GO@C materials disclosed herein or the composites made thereof. In a further embodiment, the battery is a rechargeable Li/S battery. In yet a further embodiment, the battery comprising the Li₂S/GO@C materials disclosed herein or the composites made thereof is used in consumer electronics, electric vehicles, or aerospace applications.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. “Carbon material” is also referred to herein as the “carbon shell” with respect to the disclosed composites.

The Li₂S/GO@C nano-spheres of the disclosure provide a high-rate and long-life cathode material for Li/S cells by embedding GO sheets in the Li₂S nano-spheres and depositing a conformal carbon coating on the surface. Because the Li₂S particles occupied their maximum volume relative to S at the initial stage, the carbon shell on the Li₂S/GO nano-spheres maintains good structural stability during cycling. The carbon shell not only physically surrounds the Li₂S/GO nano-spheres to prevent the direct contact between Li₂S and electrolyte, but also provides electrical conductivity during cycling. Furthermore, GO sheets embedded in the Li₂S@C act as a second barrier to prevent polysulfide dissolution due to its S immobilizing nature. This Li₂S/GO@C electrode exhibited a very high initial discharge capacity of 964 mA·h g⁻¹ of Li₂S (corresponding to 1397 mA·h g⁻¹ of S) with high Coulombic efficiency of up to 99.7% at 0.2 C. High rate cycling capability was demonstrated at various C-rates, e.g. discharge capacity of 584, 477, 394 and 185 mA·h g⁻¹ of Li₂S (845, 691, 571 and 269 mA·h g⁻¹ of S) after 150 cycles with excellent Coulombic efficiency of up to 99.7% when the electrode was discharged at 2.0, 3.0, 4.0 and 6.0 C, respectively. In long-term cycling tests, the Li₂S/GO@C electrode exhibited a specific capacity of 699 mA·h g⁻¹ of Li₂S (1012 mA·h g⁻¹ of S) at 0.05 C after 400 cycles at 2.0 C discharge and a very low capacity decay rate of only 0.046% per cycle for 1500 cycles. With these demonstrations of high sulfur utilizations, high rate capability, and long cycle life, combined with a simple fabrication process, the Li₂S/GO@C cathode can be regarded as a strong candidate for use in advanced Li/S cells.

The results provided herein demonstrate that the Li₂S@C core-shell particles deliver both high specific capacity and stable cycling performance. The following examples are intended to illustrate but not limit the disclosure. While they are typical of those that might be used, other procedures known to those skilled in the art may alternatively be used.

### EXAMPLES

Material Preparation. 1 mL of commercially available single layer graphene oxide (SLGO) dispersion in THF (CHEAP TUBE, 2 mg/mL) was sonicated using an ultrasonicator for 1 h. 3.5 mL of toluene and 64 mg of S (Alfa Aesar, −325 mesh) were added into the GO dispersion and stirred for 1 h to prepare a dissolved S-GO mixture. Then this mixture was added into 4.2 mL of 1.0 M lithium triethylborohydride in tetrahydrofuran (1M LiEt₃BH in THF, Sigma-Aldrich). After stirring for 2 min at RT, the solution was heated to 90° C. for 7-8 min under continuous stirring until stable Li2S/GO nanospheres formed. The Li₂S coated GO powder was obtained after washing with THF and hexane using centrifugation. The as prepared Li2S coated GO powder was heated at 500° C. for about 30 min under Ar atmosphere to remove organic residues and ground using a mortar and pestle. The Li2S-GO was washed with THF and hexane using centrifugation. The Li2S/GO nano-spheres were then heat-treated at 500° C. under Ar atmosphere for 30 min and ground using mortar and pestle. The weight ratio between Li₂S and GO in the Li₂S/GO nanospheres were shown to be about 98:2 by a washing method. The Li₂S-GO powder was weighed and put into a mixture of distilled water and ethanol (1:2 ratio v/v) and the solution was centrifuged at 5000 rpm for 10 min. The supernatant was collected and the pH of supernatant was checked. This procedure was repeated until the pH of the supernatant reached 7 (Note—when Li₂S reacts with H₂O, LiOH forms which increases pH value). Once the pH of the supernatant reached 7, the powder was collected and dried in a vacuum oven at 60° C. overnight. The weight ratio between Li₂S and GO was estimated by comparing the weight of the pristine and washed powders. To obtain the core-shell structured Li₂S/GO@C nano-spheres, the CVD carbon coating procedure was conducted at 700° C. for 30 min with rotation of the quartz tube using a lab-designed rotating furnace. The Ar and acetylene (C₂H₂, carbon precursor) mixture was supplied with flow rate of 100 SCCM (standard cubic centimeters per minute) and 10 SCCM, respectively. The sample was weighed before and after the CVD coating process to estimate the amount of C obtained by the CVD coating process (˜13% C was obtained). Because Li₂S is highly sensitive to moisture, all the synthesis process including furnace tube assembly was conducted in an argon filled glove box with a moisture and oxygen content below 0.1 ppm. For comparison, Li₂S spheres (1 μm) were prepared. Briefly, 64 mg Sulfur (Alfa Aesar, Sulfur powder ˜325 mesh, 99.5%) was dissolved in 3 ml toluene and then the S-toluene solution was added into 4.2 mL of 1.0 M LiEt₃BH in THF. After stirring for 2 min at room temperature, the solution was heated to 90° C. for 7 min. The Li₂S powder was collected and washed by a centrifugation method. Li₂S/GO@C-NR sample was also prepared using typical the CVD coating method under the same coating conditions without rotation of the quartz tube. The obtained carbon amount was same as that of Li₂S/GO@C nano-spheres (˜13%).

Characterization. All preparation of the samples for characterization was conducted in an argon filled glove box with a moisture and oxygen content below 0.1 ppm. Investigation of the crystal structure was conducted using an X-ray diffractometer (XRD, Bruker AXS D8 Discover GADDS microdiffractometer) with an air-free XRD holder to protect Li₂S from moisture. Raman spectra of samples (Labram, Horiba Jobin Yvon USA, Inc.) were collected in the confocal backscattering configuration with an excitation wavelength of 488 nm. To keep the sample in an inert atmosphere, a linkam cell with constant argon flow was applied. The morphology of the powdered samples was observed using a field emission scanning electron microscope (FESEM, JEOL JSM-7500F) with elemental mapping using energy-dispersive X-ray spectroscopy (EDS, Oxford). High resolution transmission electron microscopy images were collected using a JEOL TEM instrument (HRTEM, JEOL 2100-F) with elemental mapping using energy filtered TEM (EFTEM). For the polysulfide dissolution test, 1 mg of Li₂S, Li₂S/GO@C-NR, Li₂S/GO@C spheres were added into the test solution comprising 7 mg of S dissolved in 1.5 mL THF/toluene mixture solution (1:1, v/v).

Electrochemical Test. To fabricate the electrodes, 60% of Li₂S, 35% of carbon materials (including GO, carbon obtained by CVD and carbon black (Super P) as conducting agent) and 5% of Polyvinylpyrrolidone (PVP; Mw-1,300K) as binder were mixed, and then the slurry was drop-casted onto carbon fiber paper (Hesen Electrical Ltd, HCP010N; 0.1 mm thickness, 75% porosity) used as current collector, and dried. The mass loading of Li₂S in the electrodes was 0.7-0.9 mg cm². 1 M Lithium Bis(Trifluoromethanesulfonyl)Imide (LiTFSI) in N-methyl-N-butylpyrrolidinium bis(trifluoromethane sulfonyl)imide (PYR₁₄TFSI)/dioxolane (DOL)/Dimethoxyethane (DME) (2:1:1, v/v) containing 1 wt % LiNO₃ was prepared for the electrolyte. CR2325-type coin cells were fabricated with a lithium metal foil (99.98%, Cyprus Foote Mineral) as counter/reference electrode and a porous polypropylene separator (2400, Celgard) in a glove box filled with Ar gas. Galvanostatic cycling tests of the coin cells was conducted using a battery cycler (Arbin BT2000) at different rates between 1.5 and 2.8V after the first charge to 4.0 V at 0.05 C in order to activate the Li₂S.

Sulfur dissolved toluene and graphene oxide (GO) dispersion in tetrahydrofuran (THF) was first mixed and then added into a solution of lithium triethylborohydride (LiEt₃BH) in tetrahydrofuran (THF). 1 μm diameter particles of Li₂S coated GO were obtained after the THF was completely removed by heat-treatment.

The XRD diffraction pattern of Li₂S-coated GO is shown in FIG. 1. As shown in the XRD pattern, Li₂S peaks (JCPDS No. 23-0369) were successfully obtained while that of SLGO could not be observed due to the poor ordering of the graphene oxide sheets along the stacking direction.

FIG. 2 shows the SEM images of the commercial SLGO and that of Li₂S-coated GO with EDS mapping. Most of the particle sizes of the SLGO sheets shown in FIG. 2A are less than 1 μm. After the Li₂S coating process, 1 μm Li₂S-coated GO spheres were obtained. To confirm the existences of the Li₂S and GO, EDS mapping analyses were conducted. The results showed that these elements are uniformly distributed which indicate the presence of GO and Li₂S, respectively.

To demonstrate the carbon shell on the surface of the Li₂S/GO@C nanospheres, elemental mapping was conducted using energy filtered TEM (EFTEM) with a selected energy window corresponding to the Li K-edge and C K-edge. The three-window method (pre-edge, 1, 2, and postedge images) was used to subtract the background. As shown in FIG. 2d, the dark shell area in the zero loss image of Li₂S/GO@C nanospheres (inset of FIG. 2d) coincided with the C region surrounding the Li region of the Li₂S, which demonstrates the core-shell structure of the Li₂S/GO@C nanospheres with an approximately 25 nm thick carbon shell. Moreover, a very thin GO sheet was observed inside of the hollow carbon shell after removing the Li₂S from the Li₂S/GO@C nanospheres (FIG. 2e), and the typical graphitic structure of GO was verified by high resolution TEM. This proved that the thin-layered GO was successfully embedded in the Li2S particles during the synthesis process as designed to improve the electrochemical performance of the Li₂S-based cathode.

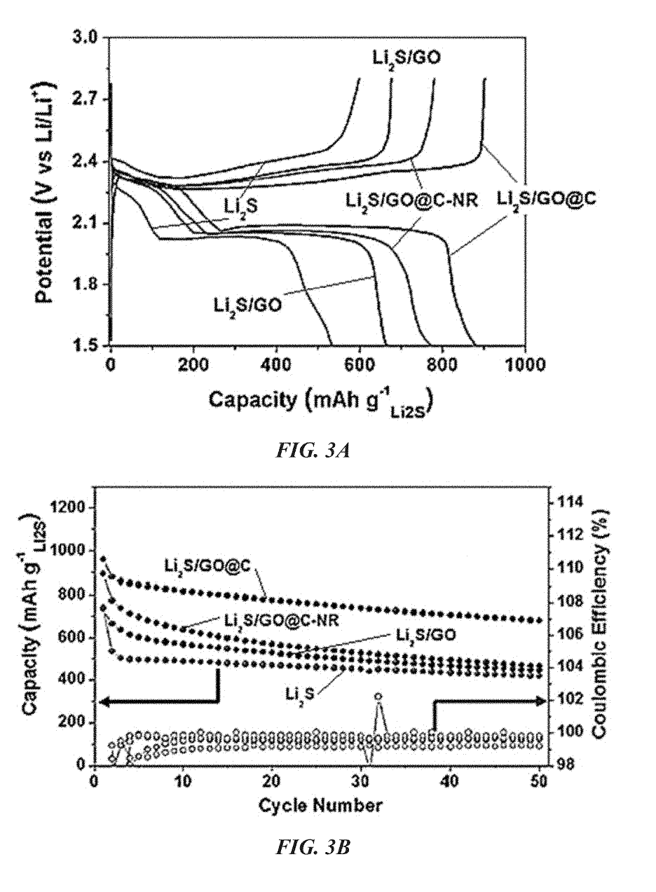

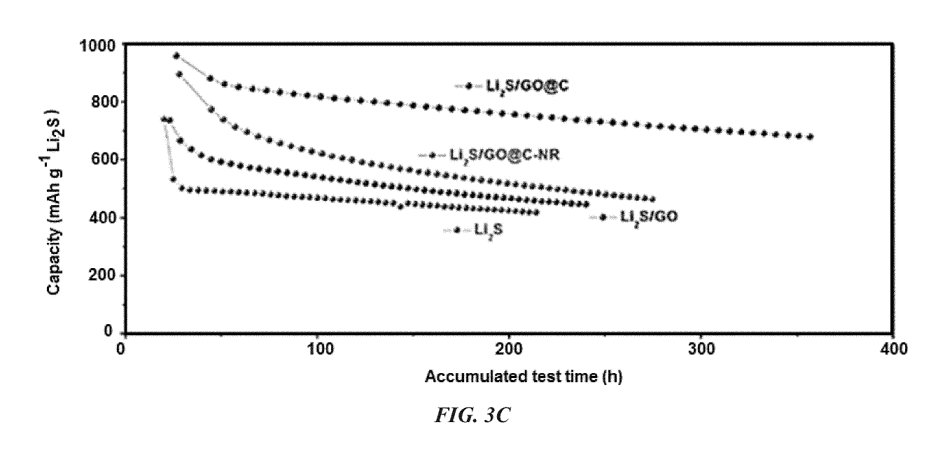

In order to verify the effect of these material modifications on the electrochemical performance, Li₂S (1 μm), Li₂S/GO, and Li₂S/GO@C obtained by a typical CVD coating process (Li₂S/GO@C-NR) and Li₂S/GO@C electrodes were fabricated. XRD patterns and SEM images of the prepared Li₂S spheres (1 μm) and Li₂S/GO@C-NR were performed and verified the crystal structures and morphologies of the synthesized Li₂S and the Li₂S/GO@C-NR particles. To fabricate the electrodes, 60% of Li₂S, 35% of carbon materials (including GO, carbon obtained by CVD, and carbon black as conducting agent) and 5% of polyvinylpyrrolidone (PVP) as binder were mixed in NMP, and then the slurries were drop-casted onto carbon fiber paper current collector. The electrolyte was composed of a mixture of PYR14TFSI/DOL/DME (2:1:1 v/v/v) containing 1 M LiTFSI and 1 wt % LiNO₃. The LiNO₃ was added to the electrolyte in order to improve the coulombic efficiency by passivating the Li metal surface against the polysulfide shuttle. The fabricated electrodes and electrolyte were employed in 2325-type coin cells with Li foil as the negative electrode. All fabrication procedures were conducted under Ar atmosphere. The fabricated cells were cycled in a voltage range between 1.5 and 2.8 V at the 0.2 C rate after the first charge to 4.0 V at 0.05 C in order to activate the Li₂S, and the results are shown in FIG. 3.

Li₂S deposited on graphene oxide was successfully shown to provide better performance and cycling stability than a Li₂S electrode without the GO. GO not only acts as an immobilizer to hold the S, but also provides a stable electrical pathway during cycling, leading to enhanced cycle performance and rate capability of the electrode.

As shown in the voltage profiles (FIG. 3a), the Li₂S/GO@C electrode exhibited the lowest charge and discharge overpotentials among all electrodes, even lower than that of the Li₂S/GO@C-NR electrode, which indicates that the carbon coating obtained by the CVD process using the rotating furnace can provide a good electrical pathway in order to overcome the insulating nature of Li₂S and S. In the comparison of the cycling performance of the electrodes (FIG. 3b), the Li₂S and the Li₂S/GO electrodes showed similar initial specific capacity of about 740 mA·h g⁻¹ of Li₂S. However, the Li₂S electrode exhibited a significant capacity decrease on the second discharge (528 mA·h g⁻¹ of Li₂S), whereas the Li₂S/GO electrodes showed a relatively gradual capacity loss (665 mA·h g⁻¹ of Li₂S). This is mainly due to the S-immobilizing nature of GO that can help to stabilize the cycling performance by suppressing polysulfide dissolution into the electrolyte. In contrast, both carbon coated electrodes, Li₂S/GO@C and Li₂S/GO@C-NR showed specific discharge capacities of up to 964 and 896 mA·h g⁻¹ of Li₂S (corresponding to 1397 and 1298 mA·h g⁻¹ of S) at the first discharge, respectively, which is much higher than those of uncoated electrodes. The high S utilization of these two electrodes can be attributed to the presence of the carbon shell that not only acts as protection to suppress the polysulfide dissolution into the electrolyte by preventing direct contact between the Li₂S and the electrolyte but also provides a better electrical pathway to compensate for the insulating nature of Li₂S and S. In addition, the Li₂S/GO@C electrode showed much better cyclability compared to Li₂S/GO@C-NR electrode for 50 cycles with a high Coulombic efficiency of up to 99.7%. This means the carbon coating layer obtained using the rotating furnace was much more effective than that of the Li₂S/GO@C-NR electrode to suppress the polysulfide dissolution into the liquid electrolyte during cycling. Capacity degradation caused by polysulfide dissolution into the liquid electrolyte can be more clearly seen in the discharge capacity vs accumulated test time plot (FIG. 3c), because the quantity of dissolved polysulfide into the liquid electrolyte from the cathode is time dependent. The more rapidly the polysulfide dissolves, the steeper the slope of the plot. As shown in FIG. 3c, Li₂S/GO@C electrode exhibited the highest capacity retention among all electrodes, whereas bare Li₂S electrode showed very steep slope for the first 30 h. After 200 h, the specific discharge capacity of the Li₂S/GO@C electrode was about 760 mA·h g⁻¹ of Li₂S, but all the other electrodes only showed 425, 465, and 520 mA·h g⁻¹ of Li₂S, respectively. It is also notable that the Li₂S/GO electrode exhibited a relatively better capacity retention than the bare Li₂S electrode, which verifies the effect of GO as S immobilizer.

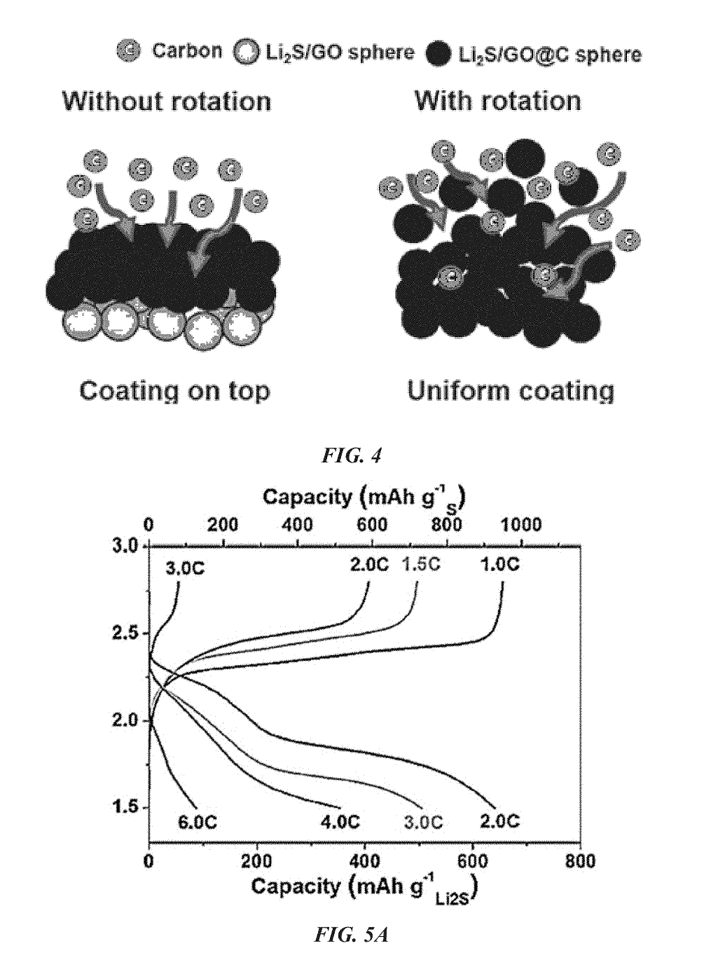

To verify the carbon protection effect of the Li₂S/GO@C nanospheres and the Li₂S/GO@C-NR nanospheres, polysulfide dissolution tests were conducted using a solution composed of THF (Li₂S is slightly soluble in THF) and toluene (S is soluble in toluene) with dissolved S. If the Li2S particles are not protected and in direct contact with the test solution, polysulfide will form and the color of the test solution will change. When the bare Li₂S was put into the test solution (Sample A), the color of the test solution immediately changed to light orange, which indicates that the bare Li₂S quickly reacted with the dissolved S and formed polysulfide. After 4 h, no solid particles of Li₂S remained in Sample A, but the test solutions of the carbon-coated samples did not show any color change. After 6 days, the test solution of Li₂S/GO@C-NR (Sample B) exhibited an orange color, whereas the test solution of the Li₂S/GO@C (batch C) was still clear and colorless. After a month, Sample C showed a slight color change, whereas both Samples A and B exhibited a dark orange color. This verifies that the conformal carbon shell of the Li₂S/GO@C successfully prevents the dissolution of Li₂S into the test solution. The results of the polysulfide dissolution test strongly support the electrochemical test results shown in FIG. 3 and indicate that the excellent cyclability of the Li₂S/GO@C electrode was achieved by the protective carbon layer formed using the methods described herein. As indicated in FIG. 4, in the typical CVD coating process, the carbon precursor gas in the quartz tube mostly flowed over the top of the bed of Li₂S/GO nanospheres, and the carbon formed from the precursor gas was mainly deposited on the top layer of the Li₂S/GO nanospheres. Therefore, multiple C deposition steps can be used to obtain a uniform carbon coating. In contrast, the Li₂S/GO nanospheres were continuously mixed in the rotating furnace through a “lifting and falling” process during the CVD coating. During this process, carbon can be deposited on the Li₂S/GO nanospheres uniformly. This one-step, conformal carbon coating facilitated the material preparation process and would greatly reduce the production cost.

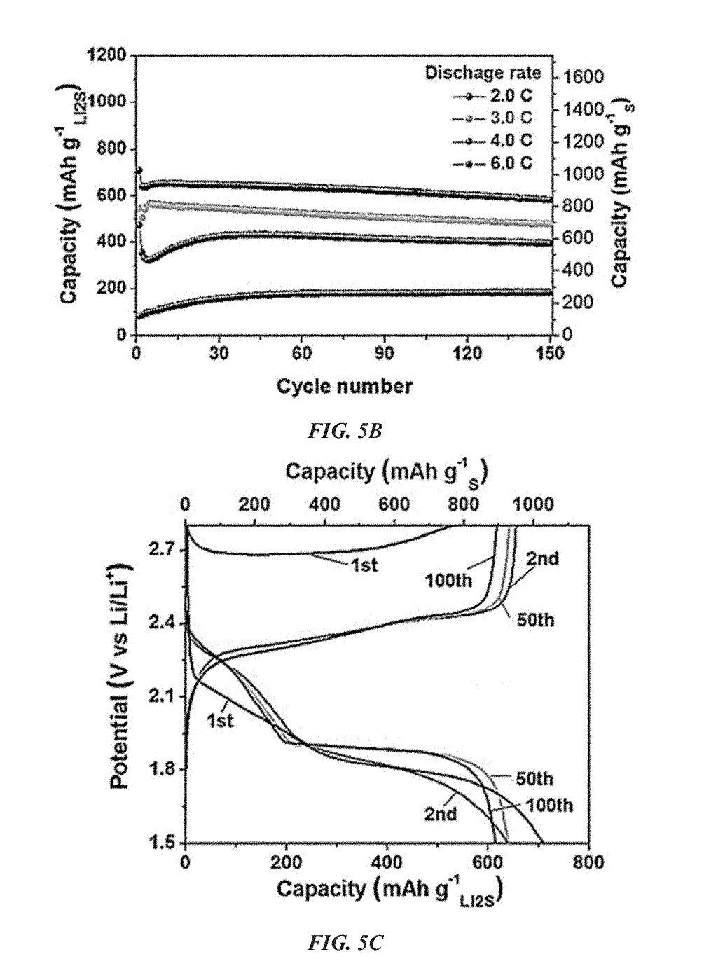

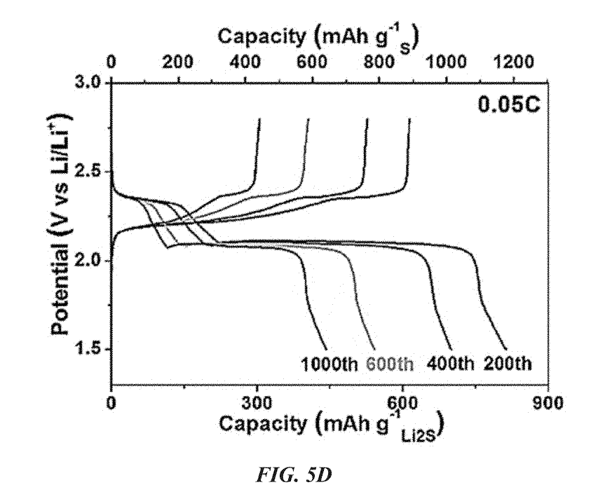

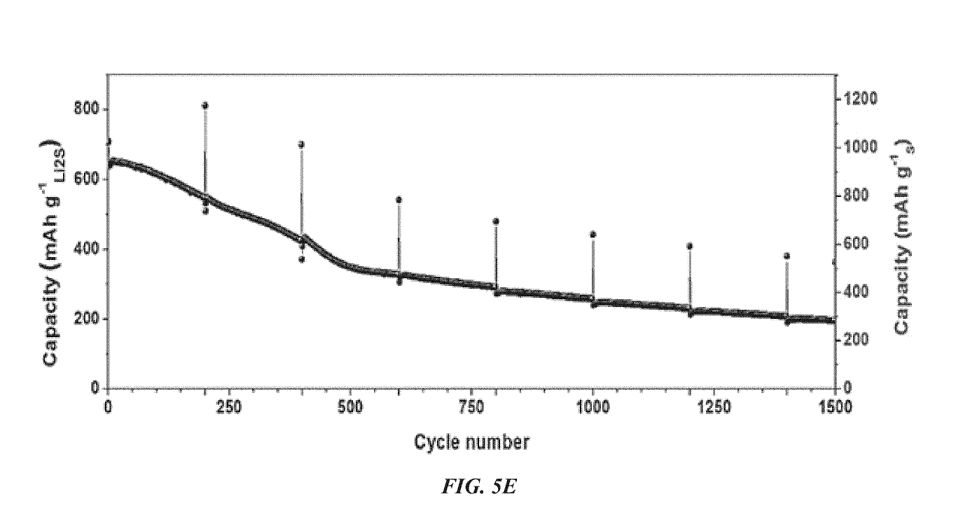

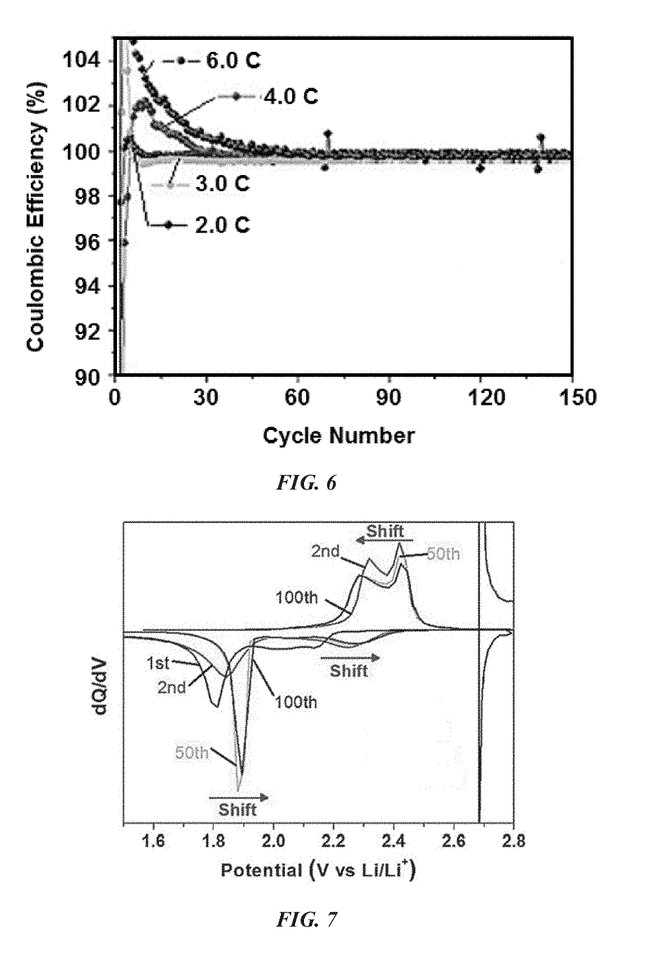

The high-rate and long-term cycling performance of the Li₂S/GO@C electrode were also investigated and the results are shown in FIG. 5. For the high-rate cycling test, the Li₂S/GO@C electrode was galvanostatically cycled at various charge (1.0, 1.5, 2.0, and 3.0 C) and discharge C-rates (2.0, 3.0, 4.0, and 6.0 C) for 150 cycles (1.0 C=1.136 A g⁻¹ of Li₂S). As shown in FIG. 5a, discharge and charge plateaus, which correspond to the formation and decomposition of Li₂S, remained in the voltage range of 1.7-1.9 V and 2.3-2.5 V, respectively, although discharge and charge overpotentials obviously increased as the applied current (C-rate) increased. This indicates that the Li₂S/GO@C electrode could undergo reversible redox reaction even when the electrode was galvanostatically cycled at discharge C-rates as high as 6.0 C. The Li₂S/GO@C electrode exhibited a discharge capacity of 584, 477, 394, and 185 mA·h g⁻¹ of Li₂S (845, 691, 571, and 269 mA·h g⁻¹ of S) after 150 cycles with a capacity retention of more than 84% and a very high Coulombic efficiency of up to 99.7% (FIG. 6) when the electrode was discharged at 2.0, 3.0, 4.0, and 6.0 C, respectively. The long-term cycling performance of the Li₂S/GO@C electrode was also demonstrated at 2.0 C discharge rate and 1.0 C charge rate for 1500 cycles and periodically cycled at 0.05 C (every 200 cycles) in order to check the S utilization at a low C-rate (FIG. 5c-e). In FIG. 5c, no significant first plateau corresponding to the formation of highly soluble high-order polysulfide (Li₂Sn, n≧4) was observed during the first discharge process, and it appeared beginning with the second discharge at around 2.3 V. This probably indicates that the carbon protective layer was very effective for preventing direct contact between S and electrolyte for the first cycle, but it was partially degraded during cycling. The differential capacity plot (DCP) (FIG. 7) corresponding to the voltage profile in FIG. 5c showed this change more clearly. FIG. 5d shows the voltage profiles of the Li₂S/GO@C electrode cycled at 0.05 C at the 200th, 400th, 600th, and 1000th cycles. A high discharge specific capacity of 812 mA·h g⁻¹ of Li₂S (1176 mA·h g⁻¹ of S) and 441 mA·h g⁻¹ (640 mA·h g⁻¹ of S) were observed after 200 cycles and 1000 cycles, respectively. The reason that the charge capacity was lower than the discharge capacity in FIG. 5d is the limited Li₂S formation caused by cycling at a high discharge C-rate (2.0 C) before the charge process at 0.05 C. During 1500 cycles, the Li₂S/GO@C electrode exhibited a very low capacity decay rate of 0.046% per cycle (FIG. 5e) with a Coulombic efficiency of higher than 99.5%, which is competitive with previous results that reported on the long-term cycling performance of Li/S cells.

In another embodiment, compositions of the disclosure can be prepare as follows: 7.5 mL, 10 mL and 12.5 mL of commercially available single layer graphene oxide (SLGO) dispersion in THF (CHEAP TUBE, 2 mg/mL) were sonicated using an ultrasonicator for 1 h, respectively. 3 mL of toluene and 64 mg of S (Alfa Aesar, −325 mesh) were added into the GO dispersions and stirred for 1 h to prepare a S dissolved GO mixture. Then these mixtures were each added into 4.2 mL of 1.0 M lithium triethylborohydride in tetrahydrofuran (1M LiEt₃BH in THF, Sigma-Aldrich) and stirred overnight at room temperature, respectively. The Li₂S coated GO powder samples with different weight ratios between Li₂S and GO were obtained after washing with hexane. The as prepared Li₂S coated GO powder samples were heated at 500° C. for 30 min under Ar atmosphere to remove organic residues.

A number of embodiments have been described herein. Nevertheless, it will be understood that various modifications may be made without departing from the spirit and scope of this disclosure. Accordingly, other embodiments are within the scope of the following claims.

1. A composition comprising nanoparticulate spheres having lithium sulfide with embedded graphene oxide (Li₂S/GO).

2. The composition of claim 1, further comprising a conformal carbon coating surrounding the Li₂S/GO.

3. The composition of claim 1, wherein the lithium sulfide core comprises embedded graphene oxide.

4. The composition of claim 2, wherein the lithium sulfide core comprises embedded graphene oxide and a conformal carbon coating.

5. The composition of claim 3, wherein the graphene oxide and lithium sulfide are heterogeneously dispersed.

6. The composition of claim 3, wherein the graphene oxide and lithium sulfide are substantially homogenously dispersed.

7. The composition of claim 3, wherein the lithium sulfide graphene oxide core has a width or diameter of about 200 nm to 1400 nm.

8. The composition of claim 3, wherein the lithium sulfide graphene oxide core has an average width or diameter of about 800 nm.

9. The composition of claim 3, wherein the conformal carbon coating comprises a shell around the lithium sulfide graphene oxide core.

10. The composition of claim 3, wherein the conformal carbon coating is about 5-45 nm thick.

11. The composition of claim 10, wherein the average thickness of the conformal carbon coating is about 25 nm.

12. A method to synthesize a lithium sulfide-graphene oxide composite material comprising:
adding a first solution comprising elemental sulfur in a nonpolar organic solvent to a second solution comprising dispersed graphene oxide in a dispersing solvent and adding a strong lithium based reducing agent to make a reaction mixture;
precipitating the Li₂S-GO material from the reaction mixture by heating the reaction mixture at an elevated temperature for 2 to 30 minutes.

13. The method of claim 12, wherein the method further comprises:
collecting the precipitated Li₂S-GO material from the reaction mixture;
washing the Li₂S-GO material; and
drying the Li₂S-GO material.

14. The method of claim 12, wherein the nonpolar organic solvent is selected from pentane, cyclopentane, hexane, cyclohexane, oxtane, benzene, toluene, chloroform, tetracloroethylene, xylene, 1,2-dichlorobenzene, 1,4-dioxane, carbon disulfide and diethyl ether.

15. The method of claim 14, wherein the nonpolar organic solvent is toluene.

16. The method of claim 12, wherein the strong lithium based reducing agent is selected from the group consisting of lithium triethylborohydride, n-butyl-lithium, and lithium aluminum hydride.

17. The method of claim 12, wherein the dispersing solvent is selected from the group consisting of acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, dichlorobenzene, dichloromethane, diethyl ether, diethylene glycol, diglyme (diethylene glycol, dimethyl ether), 1,2-dimethoxyethane (DME, glyme), dimethylether, dimethylformamide (DMF), dimethyl sulfoxide (DMSO), dioxane, ethanol, ethyl acetate, ethylene glycol, glycerin, heptane, hexamethylphosphoramide (HMPA), hexamethylphosphorous triamide (HMPT), hexane, methanol, methyl t-butyl ether (MTBE), methylene chloride, N-methyl-2-pyrrolidinone (NMP), nitromethane, pentane, petroleum ether (ligroine), 1-propanol, 2-propanol, pyridine, tetrahydrofuran (THF), toluene, triethyl amine, o-xylene, m-xylene and p-xylene.

18. The method of claim 12, further comprising coating the Li₂S/GO spheres with carbon to form a Li₂S/GO particle coated with a conformal carbon layer (Li2S/GO@C).

19. The method of claim 18, wherein the coating is performed by chemical vapor deposition (CVD).

20. The method of claim 18, wherein the coating is performed by pyrolyzing a carbon-based polymer on the spheres under an inert atmosphere so as to form a pyrolytic carbon based coating.

21. The method of claim 20, wherein the carbon based polymer is selected from polystyrene (PS), polyacrylonitrile (PAN), polymetylmetacrylate (PMMA), or combinations thereof.

22. The method of claim 21, wherein the polymer coated Li₂S/GO spheres are pyrolyzed by heating the material at a temperature between 400° C. to 700° C. for up to 48 hours.

23. A Li₂S/GO material made by the method of claim 12.

24. A Li₂S/GO@C material made by the method of claim 18.

25. An electrode comprising the Li2S/GO material of claim 1.

26. A lithium/sulfur battery comprising the electrode of claim 25.

27. An electrode comprising the Li₂S/GO@C material of claim 3.

28. A lithium/sulfur battery comprising the electrode of claim 27.
